(19) United States
(12) Patent Application Publication
(10) Pub. No.: US 2024/0001878 A1
(43) Pub. Date: Jan. 4, 2024

(54) ENERGY-ABSORBING DEVICE

(71) Applicant: Valeo Systemes Thermiques, Le Mesnil Saint-Denis (FR)

(72) Inventors: Sergio Da Costa Pito, Le Mesnil-Saint-Denis Cedex (FR); Ali Kezmane, Le Mesnil-Saint-Denis Cedex (FR); Frederic Destribats, Le Mesnil-Saint-Denis Cedex (FR)

(73) Assignee: Valeo Systemes Thermiques, Le Mesnil Saint-Denis (FR)

(21) Appl. No.: 18/254,716

(22) PCT Filed: Oct. 6, 2021
(86) PCT No.: PCT/EP2021/077597

§ 371 Date: May 26, 2023

(30) Foreign Application Priority Data
Nov. 26, 2020 (FR) 2012187

(51) Int. Cl. B60R 19/34

(52) U.S. Cl. CPC B60R 19/34

(57) ABSTRACT

The invention relates to an energy-absorbing device configured to be mounted between a bumper and a longitudinal member of a motor vehicle, the energy-absorbing device comprising at least a first part, composed of a first reinforced material and forming a reinforcement of the energy-absorbing device, and a second part, composed of a second non-reinforced material and arranged around the reinforcement, the energy-absorbing device extending in a longitudinal main direction between the bumper and the longitudinal member and comprising at least one plate which is made of a material having a hardness greater than the hardness of the second non-reinforced material and which extends across the longitudinal direction of the energy-absorbing device.

The present invention relates to the field of energy-absorbing devices with which motor vehicles are equipped. More particularly, the invention relates to the energy-absorbing devices disposed at a motor vehicle bumper.

The energy-absorbing devices of motor vehicles are usually installed between a bumper and a side member of said vehicle. Whether they be positioned at the front bumper or the rear bumper of the motor vehicle, the energy-absorbing devices have the function of at least partially absorbing the energy transferred to the vehicle during potential impacts with external elements. More particularly, the energy-absorbing devices make it possible to prevent this energy from being transmitted entirely to the side members of the vehicle and to thus limit their deformation during these impacts, it being understood that the replacement of a side member, an important structural element of the underbody of the vehicle, would require costly operations.

Such energy-absorbing devices may be produced with a structure mainly made of a metallic material, but in order to improve the absorption properties, it is known to have energy-absorbing devices which are at least partially composed of a composite material.

The use of these energy-absorbing devices, composed mainly of composite material, may give rise to a problem when a towing ring has to be installed on the motor vehicle. Usually, towing rings are positioned at one of the bumpers of the vehicle and are more particularly anchored at one of the energy-absorbing devices since this is the most rigid zone of the bumper. However, it can be seen that, when the energy-absorbing devices are composed mainly of composite material, the fastening between the energy-absorbing device and the towing ring does not exhibit satisfactory characteristics in terms of solidity. It will easily be appreciated that the connection between the towing ring and the energy-absorbing device must be solid in order to allow said towing ring to be used for the pulling of an object by the motor vehicle when the towing ring is attached to the rear bumper or for the pulling of the vehicle when the towing ring is attached to the front bumper.

The aim of the invention is therefore to overcome the aforementioned problem by proposing an energy-absorbing device whose structure and composition make it possible, on the one hand, to absorb loads in the event of shocks so as to avoid the transmission of loads to the side members of the vehicle, and, on the other hand, to ensure optimal fastening to the towing ring and thus ensure reliable use of the towing ring and of the energy-absorbing device.

In this context, the invention relates to an energy-absorbing device configured to be mounted between a bumper and a side member of a motor vehicle, the energy-absorbing device comprising at least a first part, composed of a first, reinforced material and forming a frame of said energy-absorbing device, and a second part, composed of a second, non-reinforced material which is arranged around the frame, the energy-absorbing device extending in a longitudinal main direction between the bumper and the side member and having a front end and a rear end which are opposite to each other in the longitudinal direction of the energy-absorbing device, characterized in that the energy-absorbing device comprises at least one plate which is made of a material whose hardness is greater than the hardness of the second, non-reinforced material and which extends across the longitudinal direction of the energy-absorbing device.

The energy-absorbing device has the function of at least partially absorbing the energy of an impact against the motor vehicle and more particularly an impact at that bumper of the motor vehicle which is associated with this energy-absorbing device, it being understood that this bumper may in this case be both a front bumper and a rear bumper of the vehicle. The bumper of the vehicle notably comprises a beam which extends across a front or rear face of the motor vehicle. The side member of the motor vehicle contributes to forming the underbody structure under the vehicle, and extends longitudinally over substantially the entire longitudinal dimension of the vehicle, between the front bumper and the rear bumper. The side member is thus disposed substantially perpendicularly with respect to the beam of the bumper. The energy-absorbing device is more particularly disposed between the beam and an end of one of the side members contributing to forming the underbody of the motor vehicle.

Independently of the implementation of the energy-absorbing device at the front or at the rear of the vehicle, the front end of the energy-absorbing device is defined as the end which is at least partially in contact with the beam of the bumper of the motor vehicle and the rear end of the energy-absorbing device is defined as the end which is at least partially in contact with the side member of the motor vehicle.

The first material of which the first part is composed is a reinforced material, whereas the second material of the second part is a non-reinforced material. In other words, the first material has a hardness greater than the hardness of the second material. The plate itself has a hardness greater than the hardness of the second material. Advantage is taken of such a property of the plate, combined with its positioning across the longitudinal direction of the energy-absorbing device, in that it reinforces the structure of the energy-absorbing device, without impeding its energy absorption capabilities.

According to an optional feature of the invention, the at least one plate is provided at the front end and/or the rear end of the energy-absorbing device. In other words, at least one plate is disposed at a longitudinal end of the energy-absorbing device, and if necessary a first plate may be disposed at a first longitudinal end while a second plate is disposed at a second longitudinal end.

As will be described in detail below, the front plate and, where applicable, the rear plate have the particular function of distributing the tensile loads generated during towing of the vehicle in the longitudinal extension of the energy-absorbing device. The function of the front plate is to distribute the loads over the first part of the energy-absorbing device, said first part being made of a reinforced material as specified above, and the rear plate may distribute the loads absorbed by the energy-absorbing device over a support plate for a side member of the vehicle, the energy-absorbing device being attached to said support plate.

According to an optional feature of the invention, the at least one plate comprises at least one central portion which extends across the longitudinal direction of the energy-absorbing device and around which a peripheral edge extends, said peripheral edge extending in the longitudinal direction of the energy-absorbing device.

According to an optional feature of the invention, the peripheral edge extends in the longitudinal direction of the energy-absorbing device in the direction of the center of the energy-absorbing device. Alternatively, the peripheral edge may extend in the longitudinal direction of the energy-absorbing device in the direction away from the front end of the energy-absorbing device.

According to an optional feature of the invention, the first part of the energy-absorbing device comprises at least one wall which contributes to delimiting a body of the energy-absorbing device between its front end and its rear end.

According to an optional feature of the invention, the central portion of the at least one plate is disposed so as to cover the body of the energy-absorbing device.

As specified above, according to an optional feature of the invention, the at least one plate may be provided at the front end of the energy-absorbing device and constitutes a front plate. The front plate is then the plate which is at least partially in contact with the beam of the bumper of the motor vehicle.

In this context, according to various optional features of the invention, taken alone or in combination, it may be provided that:
a towing ring is secured to the front plate; advantage is then taken of the fact that the front plate has a hardness greater than the hardness of the second material and that it is disposed across the longitudinal direction of the energy-absorbing device, in that it allows optimal retention of the towing ring to which it is attached. The tensile force exerted by the towing ring is substantially parallel to the longitudinal direction of the energy-absorbing device and the disposition of the plate across this direction reinforces the resistance of the plate to said tensile force of the towing ring;
a through-orifice is provided in the central portion of the front plate;
a connection member extends in the through-orifice in the front plate;
the connection member at least partially extends in the body of the energy-absorbing device;
the towing ring is secured to the front plate by means of the connection member.

According to an optional feature of the invention, the peripheral edge of the front plate is surrounded on either side by the second part of the energy-absorbing device.

According to an optional feature of the invention, the at least one wall of the first part of the energy-absorbing device, said wall contributing to delimiting the body of the energy-absorbing device, has an outer surface facing away from said body, the peripheral edge of the front plate extending against the outer surface of said wall.

According to an optional feature of the invention, the second part of the energy-absorbing device is overmolded on the first part of the energy-absorbing device such that it is at least in contact with the outer surface of the wall of said first part and in contact with the peripheral edge of the front plate. Advantage is taken of such a disposition of the second part of the energy-absorbing device in that it ensures the retention of the front plate against the body of said energy-absorbing device.

According to an optional feature of the invention, the peripheral edge of the front plate is clamped between the outer surface of the wall of the first part of the energy-absorbing device and the second part of the energy-absorbing device. This ensures that the plate is held in place against the front end of the energy-absorbing device.

According to an optional feature of the invention, the front plate of the energy-absorbing device extends in a first main plane that is inclined with respect to a plane perpendicular to the longitudinal direction of the energy-absorbing device.

As specified above, according to an optional feature of the invention, the at least one plate is provided at the rear end of the energy-absorbing device and constitutes a rear plate. The rear plate therefore constitutes the plate that is at least partially in contact with the side member of the motor vehicle. It should be noted that the energy-absorbing device may be equipped with a front plate and/or with a rear plate.

In this context, according to various optional features of the invention, taken alone or in combination, it may be provided that:
the rear plate comprises at least a central surface and a peripheral border which surrounds the central surface, said peripheral border extending substantially perpendicularly from said central surface;
the rear plate comprises at least one fastening hole formed in its central surface, the at least one fastening hole being configured to cooperate with at least one fastening means of the energy-absorbing device;
the rear plate comprises at least one opening forming a passage for the second material through the rear plate;
a bore is formed in the central surface of the rear plate, the bore being delimited by a raised edge;
the raised edge which delimits the bore of the rear plate at least partially extends in the body of the energy-absorbing device;
the wall of the first part of the energy-absorbing device comprises an inner surface which delimits the body of the energy-absorbing device, the raised edge of the rear plate extending against the inner surface of said wall;
the wall of the first part of the energy-absorbing device comprises an inner surface which delimits the body of the energy-absorbing device, the raised edge of the rear plate extending at a non-zero distance from said inner surface;
the second part of the energy-absorbing device is overmolded on the rear plate such that it is at least in contact with the central surface and the peripheral border of said rear plate. This ensures that the position of the rear plate within the energy-absorbing device is maintained;
the rear plate extends in a second main plane perpendicular to the longitudinal direction of the energy-absorbing device.

According to an optional feature of the invention, the second part of the energy-absorbing device at least partially extends in the body of the energy-absorbing device, said body being delimited by the wall of the first part of the energy-absorbing device. In this way, the structure of the energy-absorbing device is reinforced by at least partially filling the space formed by the wall of the first part, that is to say the body of the energy-absorbing device, by means of the second part comprising the second, non-reinforced material. Thus, the deformation of the energy-absorbing device in the event of a shock against the bumper of the motor vehicle is guaranteed while still ensuring its solidity within said motor vehicle.

According to an optional feature of the invention, the energy-absorbing device and a beam of the bumper of the motor vehicle are made in one piece.

According to an optional feature of the invention, the first part of the energy-absorbing device has an omega-shaped profile.

According to an optional feature of the invention, the first part of the energy-absorbing device extends in one piece between the front end and the rear end of said energy-absorbing device.

According to an optional feature of the invention, the first material is a composite material.

According to an optional feature of the invention, the composite material comprises fibers which extend in the longitudinal direction of the energy-absorbing device. Thus, the direction of elongation of the fibers is substantially parallel to a direction of the loads absorbed by the energy-absorbing device when the motor vehicle is subjected to a shock.

Such a feature then makes it possible to optimize the absorption of energy by the energy-absorbing device by increasing its deformation capacity.

According to an optional feature of the invention, the fibers of the composite material extend continuously from the front end as far as the rear end of the energy-absorbing device.

According to an optional feature of the invention, the second material is a plastics material.

According to an optional feature of the invention, the at least one plate is made of a metallic material.

According to an optional feature of the invention, the at least one plate is made of a material whose hardness is greater than the hardness of the first, reinforced material.

The invention also relates to a motor vehicle comprising at least one bumper, at least one side member and at least one energy-absorbing device according to any one of the preceding features, the energy-absorbing device being disposed between said bumper and said side member.

According to the invention, at least one energy-absorbing device is disposed between a front bumper of the motor vehicle and a front side member and/or a rear bumper of the motor vehicle and a rear side member.

Further features, details and advantages of the invention will become more clearly apparent from reading the description given below by way of indication, with reference to the drawings, in which:

FIG. 1 is a perspective general view of a motor vehicle comprising at least one bumper;

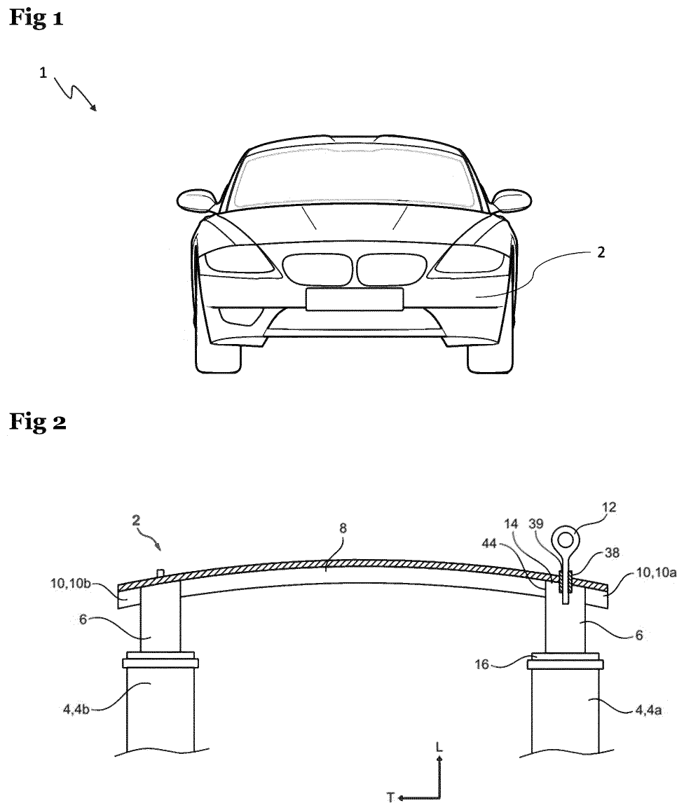

FIG. 2 is a schematic view of the bumper in FIG. 1 comprising a beam, an energy-absorbing device according to the invention and at least one side member;

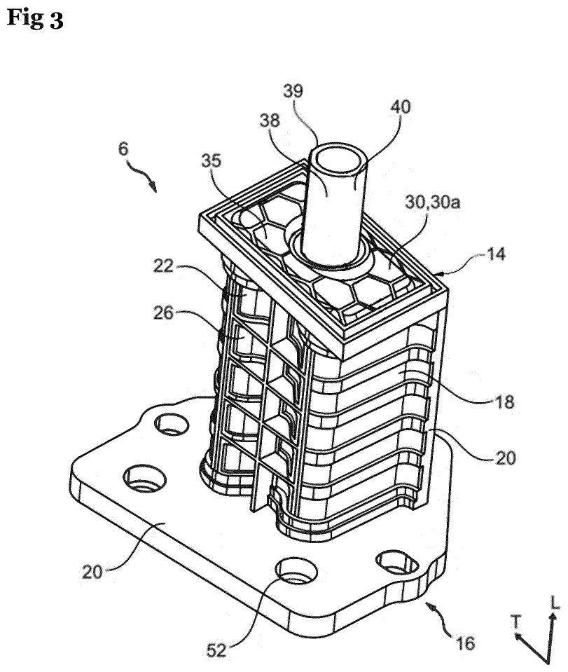

FIG. 3 is a perspective general view of the energy-absorbing device in FIG. 2 according to a first embodiment of the invention;

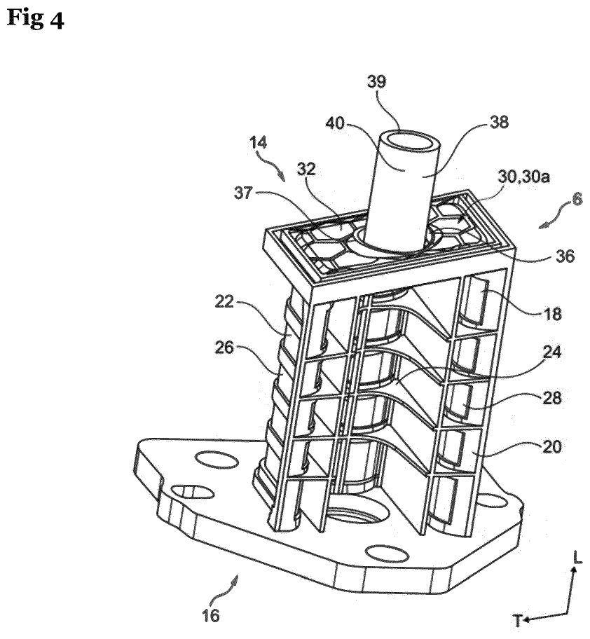

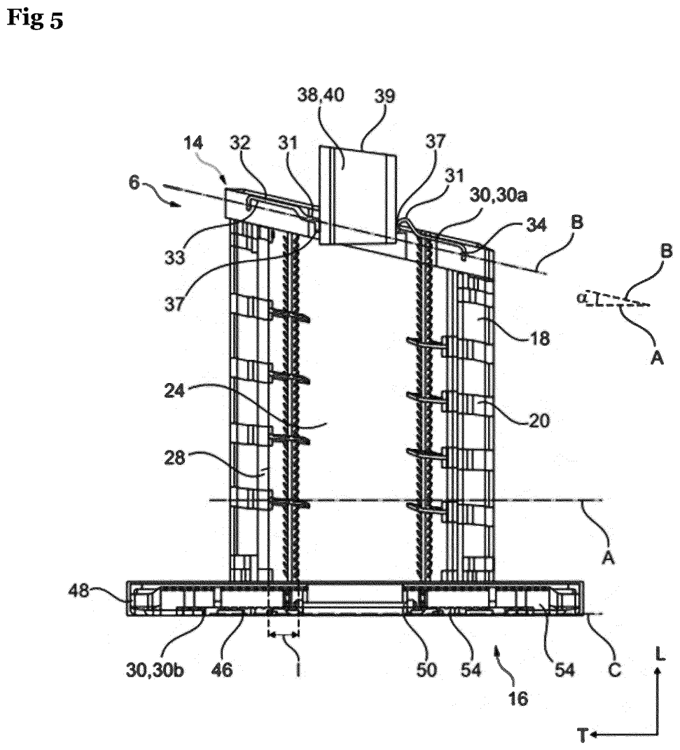

FIG. 4 is a view of the energy-absorbing device in FIG. 3, from a different perspective;

FIG. 5 is a view in section in a longitudinal and transverse plane of the energy-absorbing device in FIG. 3;

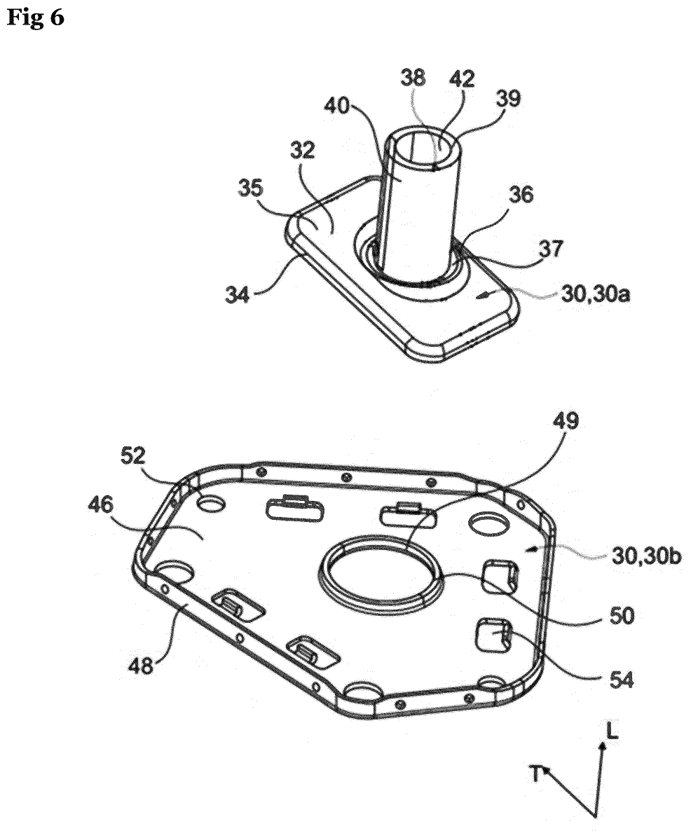

FIG. 6 is a perspective view of a front plate and of a rear plate of the energy-absorbing device in FIG. 3;

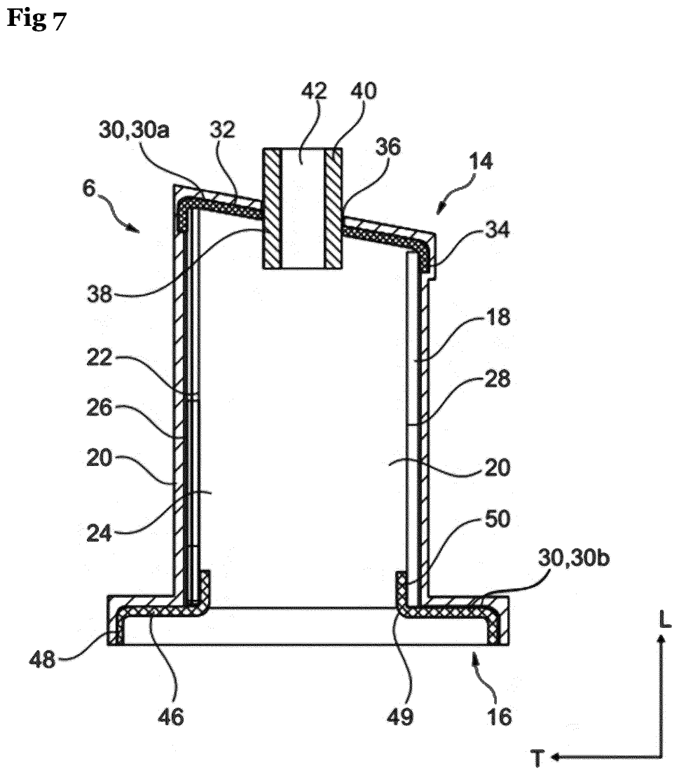

FIG. 7 is a view in section of the energy-absorbing device in FIG. 2 according to a second embodiment of the invention.

It should first of all be noted that, while the figures set out the invention in detail for the implementation thereof, these figures may of course be used to better define the invention, where appropriate. It should also be noted that these figures only set out a few exemplary embodiments of the invention, and that the same references denote the same elements in all of the figures.

A motor vehicle 1 comprises at least one bumper 2 disposed transversely at its front face, as can notably be seen in FIG. 1. According to the invention, this bumper is fastened to side members forming the underbody structure of the vehicle by energy-absorbing devices. In the remainder of the detailed description, it should be considered that the motor vehicle 1 also comprises a rear bumper (not visible here) mounted at the opposite end of the side members by way of energy-absorbing devices for a bumper that are equivalent to those which will be described in detail in the description. Thus, in the remainder of the description, bumper 2 will refer to the front bumper and the rear bumper when the features apply to both of the bumpers 2. Equivalently, the term side member 4 will refer to the front or rear part of the underbody of the vehicle when the features apply to both of the side members 4.

With reference to FIG. 2, two energy-absorbing devices 6 are arranged between the side members 4 and a front bumper 2.

The bumper 2 of the motor vehicle comprises at least one beam 8 which comprises two lateral ends 10. More precisely, the beam 8 comprises a first lateral end 10a and a second lateral end 10b which are opposite to each other along a lateral main elongation direction T of the beam 8. A first side member 4a and a second side member 4b extend respectively at the first lateral end 10a and the second lateral end 10b of the beam 8 and substantially perpendicularly with respect to the latter.

The energy-absorbing device 6 disposed between at least one of the side members 4 and one of the ends of the beam 10 has the function of reducing the structural deformation of the motor vehicle during an impact of the latter against an element external to said vehicle 1.

More precisely, and for example in the event of a frontal impact, that is to say against the front bumper 2 of the motor vehicle 1, the energy-absorbing device 6 has the function of limiting the structural damage to the front side members 4 by absorbing part of the energy released by the impact. The energy-absorbing device 6 thus has a particular structure which allows it to at least partially absorb the energy of the frontal impact, notably due to its disposition and its composition which will be described in detail in the remainder of the detailed description.

As can be seen in FIG. 2, a towing ring 12 is disposed at the front bumper 2. More precisely, the towing ring 12 is secured at least to the energy-absorbing device 6, and extends substantially perpendicularly with respect to said beam 8 of the front bumper 2. The function of the towing ring 12 is, for example, to enable the connection between the motor vehicle bearing the towing ring 12 and another vehicle, for example in the event of towing of the vehicle equipped with the ring 12. It is then possible to appreciate the need for the towing ring 12 to be anchored in an effective and reliable manner in the bumper 2 and the energy-absorbing device 6 of the motor vehicle 1. In other words, the towing ring 12 and the energy-absorbing device 6 must have a reliable connection while still allowing the deformation of the energy-absorbing device 6 so that it limits the deformation of the side member 4 in the event of an impact.

The at least one energy-absorbing device 6 extends between the first side member 4a and the beam 8, at the first lateral end 10a of this beam 8. More precisely, the energy-absorbing device 6 extends in a longitudinal main direction, hereinafter called longitudinal direction L, substantially perpendicular to the lateral main elongation direction T of the beam 8, between the bumper 2 and the side member 4. The energy-absorbing device 6 comprises a front end 14 and a rear end 16, which are opposite to each other in the longitudinal direction L of the energy-absorbing device 6, the front end 14 then being the end in contact with the beam 8 and the rear end 16 being the end in contact with the side member 4. The towing ring 12 described above extends mainly in the longitudinal direction L of the energy-absorbing device 6, and is secured to this energy-absorbing device 6 at its front end 14. The connection between the towing ring 12 and the energy-absorbing device 6 will be described in more detail in the remainder of the detailed description.

It should be considered that an energy-absorbing device according to the invention can be mounted between the second side member and the second lateral end of the beam, but that it is possible to provide an energy-absorbing device in accordance with what may exist in the prior art, since it is not expected that the towing ring be arranged in the extension of the second side member but only in the extension of the first side member.

The energy-absorbing device 6 according to the invention will now be described in more detail, notably by means of the description of a first embodiment with reference to FIGS. 3 to 6 and then by means of the description of a second embodiment with reference to FIG. 7.

According to the first embodiment, the energy-absorbing device 6 comprises at least a first part 18, composed of a first, reinforced material, and a second part 20, composed of a second, non-reinforced material. More precisely, the first part 18 forms a frame of the energy-absorbing device 6 and the second part 20 is arranged around this frame. The use of a reinforced material has the result that the first material has a hardness greater than the hardness of the second, non-reinforced material. According to an example of the invention, the first material is a composite material which comprises fibers which extend in the longitudinal direction L of the energy-absorbing device 6. Provision may also be made for these fibers to extend continuously from the front end 14 as far as the rear end 16 of the energy-absorbing device 6. Still according to an example of the invention, the second material may be a plastics material.

As can be seen in particular in FIGS. 3 and 6, the first part 18 of the energy-absorbing device 6 extends in one piece between the front end 14 and the rear end 16 of said energy-absorbing device 6 and comprises at least one wall 22 which contributes to delimiting a body 24 of the energy-absorbing device 6, between its front end 14 and its rear end 16. The wall 22 of the first part 18 of the energy-absorbing device 6 then has an outer surface 26 facing away from said body 24 and an inner surface 28 facing toward the interior of the body 24. According to an exemplary embodiment of the invention, the first part 18 of the energy-absorbing device 6 may have, in a plane perpendicular to the longitudinal direction L of the energy-absorbing device 6, an omega-shaped profile. It will then be appreciated from the foregoing that, in this first embodiment, the body 24 of the energy-absorbing device 6, said body being delimited by the wall 22 of the first part 18, has a profile with an open cross section, such that the body is open to the outside of said energy-absorbing device 6, as can be seen in particular in FIG. 4.

The second part 20 of the energy-absorbing device 6, said second part being overmolded on the first part 18 of the energy-absorbing device 6 such that said second part 20 is in contact with at least a part of the outer surface 26 of the wall 22 of said first part 18, can notably be seen in FIG. 3. Also, and as can be seen in FIG. 4, the second part 20 is overmolded on the first part 18 of the energy-absorbing device 6 such that said second part 20 is in contact with at least a part of the inner surface 28 of the wall 22 of said first part 18. In other words, the second part 20 extends in the body 24 of the energy-absorbing device 6 against the inner surface 28 of the wall 22 which contributes to delimiting the body 24 of the energy-absorbing device 6.

According to the example of the invention that can be seen in FIG. 3, the second part 20 has a perforated structure which extends against the outer surface 26 and the inner surface 28 of the wall 22 of the first part 18 from the rear end 16 as far as the front end 14 of the energy-absorbing device 6. The perforated structure of the second part 20, as it extends on either side of the first part 18 against the outer surface 26 and the inner surface 28 of the wall 22, makes it possible to offer a good compromise between, on the one hand, the ability of the energy-absorbing device to withstand loads when the beam is subjected to small shocks, and, on the other hand, the desired deformation of the energy-absorbing device 6 in the event of a violent impact against the bumper 2 of the motor vehicle 1, in which case it is desired that the energy generated by this impact is not transmitted, or only to a small extent, to the side members of the vehicle.

According to the invention, the energy-absorbing device 6 comprises at least one plate 30 which is made of a material whose hardness is greater than the hardness of the second, non-reinforced material and which extends across the longitudinal direction L of the energy-absorbing device 6. Additionally, the hardness of the at least one plate 30 may be greater than the hardness of the first, reinforced material and may be made, for example, of a metallic material.

The at least one plate 30 comprises at least one central portion 32 which extends across the longitudinal direction L of the energy-absorbing device 6 and around which a peripheral edge 34 extends which extends the central portion 32 substantially perpendicularly, in the longitudinal direction L of the energy-absorbing device 6. The central portion 32 of the plate 30 extends so as to cover the body of the energy-absorbing device 6, at its front end 14 and/or its rear end 16, and has a substantially parallelepipedal shape.

According to the illustrated example of the invention, the energy-absorbing device 6 comprises a front plate 30a positioned at the front end 14 of the energy-absorbing device 6, and a rear plate 30b positioned at the rear end 16 of the energy-absorbing device 6. In other words, the front plate 30a extends so as to cover the body 24 of the energy-absorbing device 6 at its front end 14 and the rear plate 30b extends so as to cover the body 24 at the rear end 16.

The front plate 30a comprises at least one through-orifice 36 which is formed in its central portion 32 and which in this case has a circular shape. The through-orifice 36 in the front plate 30a makes it possible to form a passage through the front plate 30a toward the interior of the body 24 of the energy-absorbing device 6. The through-orifice 36 is passed through at least by a connection member 38. More precisely, the through-orifice 36 is delimited peripherally by an orifice wall 37 which forms a bushing around said through-orifice 36, the bushing having a main elongation direction parallel to the longitudinal direction L of the energy-absorbing device 6. Such an arrangement makes it possible, on the one hand, to facilitate the insertion and the positioning of the connection member 38 through said through-orifice 36, the bushing providing a means for guiding the connection member 38, and, on the other hand, to make it easier to maintain the position of the connection member 38 with respect to the longitudinal direction L of the energy-absorbing device 6, the longitudinal dimension of the bushing making it possible to avoid the pivoting of the connection member under loads.

More precisely, the connection member 38 comprises at least one sleeve 40 forming a hollow cylindrical envelope along the longitudinal direction L of the energy-absorbing device 6. The sleeve 40 is then in contact with the orifice wall 37 of the through-orifice 36 and is secured to the front plate 30 30a, for example by welding, notably when the connection member 38 and the front plate 30a are formed of the same, notably metallic, material.

The connection member 38 passes through the front plate 30a, such that this connection member extends partly outside a volume defined by the energy-absorbing device 6 in the longitudinal direction L of the latter and partly in the body 24 of the energy-absorbing device 6. The connection member 38 extends successively, along the longitudinal direction L of the energy-absorbing device 6, in the body 24 of the energy-absorbing device 6, through the front plate 30a via the bushing 37 delimiting the through-orifice 36 and then in the thickness of the beam 8 and has a free end 39, as can be seen in FIG. 2, protruding from the beam 8, toward the outside of the vehicle.

Advantage is taken of the free end 39 of the connection member 38 which goes beyond the beam in that it facilitates the introduction of the towing ring 12 into the sleeve 40 of said connection member 38.

The towing ring 12, which can be seen in FIG. 2, extends in the connection member 38. More particularly, the towing ring 12 comprises a stem, which cooperates with the sleeve 40 of the connection member 38, and a head which forms the ring at one end of the stem and which protrudes from the beam 8 so that it is able to receive a tow hook. According to an advantageous configuration, in the direction away from the head, the stem of the towing ring 12 may extend beyond the sleeve 40 of the connection member 38, as far as in the body 24 of the energy-absorbing device 6, as can be seen in FIG. 2.

The towing ring 12 is secured to the connection member 38 by a securing means which may be a screwing operation carried out by cooperation of a thread formed on the stem of the towing ring 12 with a tapped thread formed in the sleeve 40 of said connection member 38. The towing ring 12 is thus secured to the connection member 38, and therefore to the front plate 30a of the energy-absorbing device 6.

The peripheral edge 34 of the front plate 30a extends in the longitudinal direction L of the energy-absorbing device 6, in the direction of the rear end 16 of the energy-absorbing device 6. The second part 20 of the energy-absorbing device 6, which is overmolded on the first part 18 of the energy-absorbing device 6, also extends at least in contact with the peripheral edge 34 of the front plate 30a. More precisely, the second part 20 of the energy-absorbing device 6 is overmolded around the peripheral edge 34 of the front plate 30a such that the second part 20 is interposed between the first part 18 of the energy-absorbing device 6 and said peripheral edge 34 of the front plate 30a, as can be seen in FIG. 5. Thus, it should be noted that the front plate 30a extends at a distance from the first part 18 and its perpendicular position with respect to the longitudinal direction L of the energy-absorbing device 6 is maintained by the presence of the second part 20.

An inner face 33 of the central portion 32 of the front plate 30a, said inner face facing toward the body 24 of the energy-absorbing device 6, and an outer face 35 of the central portion 32 of the front plate 30a, said outer face being opposite to the inner face 33 in the longitudinal direction L of the energy-absorbing device 6, are defined. The second part 20 of the energy-absorbing device 6 which extends in overmolded fashion on the peripheral edge 34 of the front plate 30a also extends so as to cover the inner face 33 of the central portion 32 of said front plate 30a. The second part 20 of the energy-absorbing device 6 also extends so as to partially cover the outer face 35 of the central portion 32 of the front plate 30a. More precisely, the second part 20 extends in such a way that it forms a honeycomb mesh against the outer face 35 of the central portion 32 of the front plate 30a. According to a variant of the invention that is not shown here, the mesh may be square, triangular or rectangular, the size of the mesh having a sufficient dimension to ensure mechanical integrity in a context of optimizing the cost and weight of the part.

Such overmolding of the second part 20 of the energy-absorbing device 6 on the peripheral edge 34 of the front plate 30a, its inner face 33 and its outer face 35 as has just been described makes it possible to reliably maintain the position of the front plate 30a against the body 24 of the energy-absorbing device 6.

As can be seen in FIG. 5, the front end 14 of the energy-absorbing device 6 has an inclination with respect to a plane A, perpendicular to the longitudinal direction L of said energy-absorbing device 6. In other words, the front end 14 of the energy-absorbing device 6, and notably the front plate 30a disposed at this front end 14, extends mainly in an end plane B which is inclined, at an angle α of between 1° and 45°, with respect to the plane A perpendicular to the longitudinal direction L of the energy-absorbing device 6.

This particular inclination of the front end 14 of the energy-absorbing device 6 allows the latter to optimally conform to the shape of the beam 8 of the motor vehicle in line with the side members 4, as can be seen in FIG. 2, and more precisely at a housing 44 of the beam 8, formed at its first lateral end 10a.

This inclination of the front plate 30a results in a particular configuration of the bushing formed by the orifice wall 37. On either side of the sleeve 40 forming the connection member 38, the orifice wall 37 results, on one side, from a boss protruding from the front plate in the direction away from the body 24 of the energy-absorbing device, and results, on the other side, from a depression forming a hollow in the front plate. Such a configuration allows the orifice wall 37 to extend the front plate 30a by way of an intermediate portion 31 which is substantially perpendicular to the longitudinal elongation direction of the connection member, in order to optimize the management of the towing loads via the towing ring inserted in the sleeve of the connection member.

As can be seen in particular in FIG. 6, the rear plate 30b of the energy-absorbing device 6 comprises at least one central surface 46 and a peripheral border 48 which surrounds the central surface 46, said peripheral border 48 of the rear plate 30b substantially perpendicularly extending said central surface 46 at its periphery. A bore 49 is formed substantially in the center of the central surface 46 of the rear plate 30b, such that it opens out into the interior the body 24 of the energy-absorbing device 6. The bore 49 is delimited by a raised edge 50 which is circular in this case and which substantially perpendicularly extends the central surface. The raised edge 50 which peripherally delimits the bore 49 of the rear plate 30b thus extends in the longitudinal direction L of the energy-absorbing device 6 and in the direction of its front end 14. In other words, the rear plate 30b has a front face facing toward the body 24 of the energy-absorbing device 6 and the raised edge 50 protrudes from this front face of the rear plate.

According to the invention, the bore 49 of the rear plate 30b is dimensioned such that the raised edge 50 at least partially extends in the body 24 of the energy-absorbing device 6. As can be seen in FIG. 5, the raised edge 50 of the bore 49 of the rear plate 30b extends at a non-zero distance I from the inner surface 28 of the wall 22 of the first part 18, this distance being measured along a straight line perpendicular to the longitudinal direction L of the energy-absorbing device 6.

As can be seen in FIG. 5, the central surface 46 of the rear plate 30b extends over a larger area than that defined by the projection of the body 24 of the energy-absorbing device 6 in the plane A perpendicular to the longitudinal direction L of the energy-absorbing device 6. Such a configuration of the central surface 46 of the rear plate 30b facilitates the fastening of the energy-absorbing device 6 to the side member 4 at the rear end 16 of the energy-absorbing device 6, notably by permitting the formation of at least one fastening hole 52 in the material of the rear plate 30b, in a peripheral zone of the central surface 46 not covered by the body 24.

More precisely, a plurality of fastening holes 52 are formed in this peripheral zone of the central surface 46 of the rear plate 30b, the holes being substantially distributed over this peripheral zone. The purpose of the plurality of fastening holes 52 is to allow the the energy-absorbing device 6 to be fastened to that side member 4 of the motor vehicle with which it is associated, in this case the first side member 4a of said vehicle. To this end, each of the fastening holes 52 is configured to cooperate with at least one fastening means (not visible) of the energy-absorbing device 6, said fastening means being capable of also cooperating with the side member 4 of the motor vehicle. The fastening means may be a screw, for example.

As can be seen in FIG. 6, a plurality of openings 54, separate from the fastening holes 52, are formed in the central surface 46, again in the peripheral zone which consists of a portion of the central surface 46 not covered by the body 24 of the energy-absorbing device 6. The function of the plurality of openings 54 is to form a passage for the second material so that the latter becomes permeated in the thickness of the rear plate 30b during its injection so as to cover said rear plate 30b and ensures the integrity of the rear plate.

The second part 20 of the energy-absorbing device 6 is overmolded on the rear plate 30b, as can be seen in FIG. 3, such that the second part 20 extends at least so as to cover the central surface 46 of the rear plate 30b. More precisely, the second part 20 of the energy-absorbing device 6 covers the central surface 46, the peripheral border 48, the raised edge 50 of the bore 49 of the rear plate 30b, and also the plurality of openings 54 formed in said central surface 46. There is thus a distinction between the openings 54 which are filled with the second material forming the second part 20 and the fastening holes 52 for which it is ensured, for example by plugging them during the injection of the second material or by producing these holes after the injection of the second material, that they are not blocked so as to not obstruct the passage of the provided fastening means.

As can be seen in particular in FIG. 5, the rear plate 30b extends in a second main plane C, which is perpendicular to the longitudinal direction L of the energy-absorbing device 6 and therefore parallel to the plane A mentioned above. In this way, and in connection with what has been mentioned above, the front plate 30a extends in an inclined manner with respect to the rear plate 30b, the inclination being determined with respect to the longitudinal direction L of the energy-absorbing device 6. It is notable that the rear plate 30b is arranged such that its rear face, facing in the direction away from the body 24, is perpendicular to the longitudinal direction of the energy-absorbing device 6 so as to facilitate the pressing of the energy-absorbing device against a plate formed at the end of the corresponding side member. In this context, it should be noted that the second material injected to form the second part does not extend so as to cover the rear face, in order to make it easier to obtain a planar surface for the fastening to the plate of the corresponding side member.

The second embodiment of the invention as mentioned above will now be described with regard to FIG. 7, which shows a view in longitudinal section of the energy-absorbing device 6. In the remainder of the description, it should be considered that only features that differ from the first embodiment of the invention will be mentioned. For common features, reference should be made to the description of the first embodiment given with reference to FIGS. 3 to 6. It is notably considered that the front plate 30a and the rear plate 30b have a disposition along their respective plane B, C that is identical to what has been described in detail in the first embodiment of the invention.

In this second embodiment, the second part 20 of the energy-absorbing device 6 extends in the body 24 of the energy-absorbing device 6, said body being delimited by the wall 22 of the first part 18, such that the entire space defined inside the body 24 is filled with the second material forming the second part 20. Such a disposition of the second part 20 of the energy-absorbing device 6 within the body 24 of the latter makes it possible to reinforce its structure so that the bumper and the energy-absorbing devices maintain their integrity in the event of small shocks, while still allowing deformation of the energy-absorbing device 6 in the event of greater shocks, the second part 20 being made up of non-reinforced material.

According to this second embodiment of the invention, the central portion 32 of the front plate 30a is dimensioned such that the peripheral edge 34 of the front plate 30a extends against the outer surface 26 of the wall 22 of the first part 18 of the energy-absorbing device 6. It will then be appreciated that, in this second embodiment of the invention, when the second part 20 of the energy-absorbing device 6 is overmolded on the peripheral edge 34 of the front plate 30a, said peripheral edge 34 is clamped between the outer surface 26 of the wall 22 of the first part 18 of the energy-absorbing device 6 and the second part 20 of the energy-absorbing device 6. It will then be appreciated that such an arrangement between the first part 18, the peripheral edge 34 of the front plate 30a and the second part 20 makes it possible to firmly hold said front plate 30a so as to cover the body 24 of the energy-absorbing device 6 at its front end 14.

Still according to the second exemplary embodiment of the invention, the peripheral border 48 of the rear plate 30b extends perpendicularly from the central surface 46 and in the direction of the side member of the motor vehicle. In other words, the peripheral border 48 protrudes from the rear face of the rear plate 30b, in the direction away from the volume defined by the body 24 of the energy-absorbing device 6. Another difference is that the raised edge 50 of the bore 49 of the rear plate 30b extends against the inner surface 28 of the wall 22 of the first part 18. It will then be appreciated from the foregoing that the raised edge 50 of the bore 49 is clamped between the inner surface 28 of the wall 22 of the first part 18 and the second part 20 of the energy-absorbing device 6 which extends in the body 24 of the energy-absorbing device 6.

This improves the transmission, to the side members, of the loads absorbed by the energy-absorbing device in the event of small shocks, or when the vehicle is towed via the towing ring secured to the energy-absorbing device. The rear plate 30b retains its role described above of distributing the loads over the entire plate formed at the end of the side member, and the fact that this rear plate is in direct contact with the wall 22 of the first part permits a direct transfer of the loads and an improved ability of the vehicle structure to withstand loads generated by towing operations.

As can be seen in FIG. 7, the second part 20 may be injected so as to fill both the interior of the body 24 and the internal volume defined by the peripheral edge 48 and the central surface 46 of the rear plate.

The energy-absorbing device 6 as has just been described may be manufactured by assembling the first material of the first part 18 with the front plate 30a and the rear plate 30b, then overmolding the second material of the second part 20 on the assembly described above. The energy-absorbing device 6 thus formed is then disposed, and secured, in the motor vehicle, notably with the corresponding side member 4 and the beam 8 of the bumper 2.

According to another variant for manufacturing the energy-absorbing device 6, the latter may first comprise a step of assembling the first material with the front plate 30a and the rear plate 30b, then a step of overmolding the second material forming the second part 20 of the energy-absorbing device 6, but in such a way that the second material also forms the beam 8 of the bumper 2. In other words, the energy-absorbing device 6 and the beam 8 of the motor vehicle are made in one piece.

The invention as has just been described therefore makes it possible, through simple means, to increase the solidity of the connection between a towing ring and an energy-absorbing device, while retaining the deformation and energy absorption properties of the latter.

The invention as has just been described is not, however, limited to the means and configurations exclusively described and illustrated, but also applies to all equivalent means or configurations and to any combination of such means or configurations.

1. An energy-absorbing device configured to be mounted between a bumper and a side member of a motor vehicle, the energy-absorbing device comprising:
at least a first part, composed of a first, reinforced material and forming a frame of said energy-absorbing device;
a second part, composed of a second, non-reinforced material which is arranged around the frame, the energy-absorbing device extending in a longitudinal main direction between the bumper and the side member and having a front end and a rear end which are opposite to each other in the longitudinal direction of the energy-absorbing device; and
at least one plate which is made of a material whose hardness is greater than the hardness of the second, non-reinforced material and which extends across the longitudinal direction of the energy-absorbing device.

2. The energy-absorbing device as claimed in claim 1, wherein the first part of the energy-absorbing device comprises at least one wall which contributes to delimiting a body of the energy-absorbing device between its front end and its rear end.

3. The energy-absorbing device as claimed in claim 2, wherein the at least one plate comprises at least one central portion which extends across the longitudinal direction of the energy-absorbing device and around which a peripheral edge extends, said peripheral edge extending in the longitudinal direction of the energy-absorbing device.

4. The energy-absorbing device as claimed in claim 3, wherein the central portion of the at least one plate is disposed so as to cover the body of the energy-absorbing device.

5. The energy-absorbing device as claimed in claim 1, wherein the at least one plate is provided at the front end of the energy-absorbing device and constitutes a front plate.

6. The energy-absorbing device as claimed in claim 5, wherein a towing ring is secured to the front plate.

7. The energy-absorbing device as claimed in claim 5, wherein the front plate of the energy-absorbing device extends mainly in a first main plane that is inclined with respect to a plane perpendicular to the longitudinal direction of the energy-absorbing device.

8. The energy-absorbing device as claimed in claim 1, wherein the at least one plate is provided at the rear end of the energy-absorbing device and constitutes a rear plate.

9. The energy-absorbing device as claimed in claim 8, wherein the rear plate extends in a second main plane perpendicular to the longitudinal direction of the energy-absorbing device.

10. A motor vehicle comprising:
at least one bumper, at least one side member and at least one energy-absorbing device as claimed in claim 1, the energy-absorbing device being disposed between said bumper and said side member.
